(19) United States
(12) Patent Application Publication
(10) Pub. No.: US 2008/0266352 A1
(43) Pub. Date: Oct. 30, 2008

(54) FLUID EJECTING APPARATUS AND CONTROL METHOD THEREOF

(75) Inventor: Nobuhito TAKAHASHI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/109,383

(22) Filed: Apr. 25, 2008

(30) Foreign Application Priority Data
Apr. 26, 2007 (JP) 2007-117257

(51) Int. Cl. B41J 2/165

(52) U.S. Cl. 347/32

(57) ABSTRACT

A liquid ejecting apparatus with a capping mechanism capable of performing a capping operation to cap the nozzle openings of a liquid ejecting head wherein groups of symmetrically arranged caps are moved toward the nozzle openings in a series of predetermined intervals so as not to apply an excessive load on the liquid ejecting head.

The entire disclosures of Japanese Patent Application No. 2007-117257, filed Apr. 26, 2007 is expressly incorporated herein by reference.

### BACKGROUND OF THE INVENTION

1. Technical Field

The present invention relates to a liquid ejecting apparatus that is capable of ejecting a fluid or liquid from a plurality of nozzle openings. More particularly, the present invention relates to a system and method of enclosing the nozzle openings with a cap when the nozzle openings are not performing a liquid ejecting operation.

2. Related Art

One example of a commonly used liquid ejecting apparatus is an image recording apparatus, such as an ink jet printer, which discharges and deposits ink droplets onto a recording medium, such as a recording paper or the like, to perform a recording operation. In recent years, however, liquid ejecting apparatuses have been increasingly used in various other manufacturing apparatuses, beyond image recording apparatuses. For example, other liquid ejecting apparatuses are also used apparatuses for manufacturing displays, such as a liquid crystal displays, a plasma displays, organic EL (Electro Luminescence) displays, and an FEDs (Field Emission Displays). Moreover, liquid ejecting apparatuses are also used to discharge various liquid materials, such as color materials or electrode materials, onto image forming regions or electrode forming regions.

One example of a liquid ejecting apparatus is disclosed in Japanese Patent Application No. JP-A-2004-268563, which describes an ink jet printer that includes an ink jet recording head. The disclosed recording head has a plurality of nozzles and a nozzle surface, and a nozzle opening of each nozzle is formed in the nozzle surface. The recording head ejects ink from the nozzle openings to record an image of a recording medium. However, when the recording head is not performing a printing or recording operation, caps are mounted on the nozzle openings so as to prevent ink from drying and clogging the nozzles, and to prevent dust or dirt from sticking to the nozzle openings. Specifically, in the printer described in JP-A-2004-268563, six caps are provided for the recording head. During the period of time when the recording head is not performing a printing process, the six caps are brought into contact with the recording head, in order to completely enclose the nozzle openings (capping state). That is, in the printer described in the above-described document, the six caps, which are spaced from the recording head, are moved to and brought into contact with the recording head.

In another known technology, a mechanism is used that brings and presses the caps into contact with the recording head while simultaneously presses to perform a sufficient capping operation. During this capping operation, the caps are preferably pressed against the recording head and brought into close contact with the recording head so that the inside of each of the caps is vacuumized to generate a negative pressure inside of the cap, thereby eliminating any clogging at the nozzles.

Generally, the plurality of caps are moved to and pressed against the liquid ejecting head (recording head) using a driving force supplied from a driving source, such as a stepping motor or the like. One disadvantage of this system, however, is that when the plurality of caps simultaneously come into contact with the liquid ejecting head, an excessive load may be imposed on the driving source, which may cause problems. More specifically, a large load may be generated on the driving source when the plurality of caps come into contact with the liquid ejecting head, causing the driving source to stop. As a result, the caps may not be appropriately brought into contact with and pressed against the liquid ejecting head, and thus a good capping state may not be realized.

### BRIEF SUMMARY OF THE INVENTION

An advantage of some aspects of the invention is that it provides a technology capable of reducing a change in a load on a driving source when a plurality of caps come into contact with a liquid ejecting head, thereby realizing a good capping state.

One aspect of the invention is a liquid ejecting apparatus, comprising a liquid ejecting head comprising nozzles capable of ejecting a liquid from a plurality of nozzle openings formed in a nozzle opening plane, a cap array that has three or more caps symmetrically arranged in an arrangement direction that is parallel with the nozzle opening plane with a symmetry axis that is perpendicular to the arrangement direction. The caps are capable of moving in a cap moving direction to be brought into contact with the liquid ejecting head, so as to enclose the nozzle openings. The liquid ejecting apparatus further comprises a cap moving unit that is capable of performing a capping operation for each cap, where each cap is moved toward the liquid ejecting head in the cap moving direction so as to be brought into contact with the liquid ejecting head at a series of predetermined contact timings, and pressed against the liquid ejecting head, and a driving source capable of supplying a driving force for moving the caps toward the cap moving unit. In the liquid ejecting head at least two of the caps are brought into contact with the liquid ejecting head at different contact timings, and wherein caps arranged symmetrically with respect to the symmetry axis are brought into contact with the liquid ejecting head at the same contact timing.

A second aspect of the invention is a method of controlling a liquid ejecting apparatus comprised of a liquid ejecting head, which has a plurality of nozzles capable of ejecting a liquid from nozzle openings formed in a nozzle opening plane of the liquid ejecting head and a cap array comprised of three or more caps capable of moving in a cap moving direction toward and contacting the liquid ejecting head so as to enclose the nozzle openings of the liquid ejecting head. The method comprises performing a capping operation using a driving force capable of moving the caps toward the liquid ejecting head in the cap moving direction, bringing the caps into contact with the liquid ejecting head at a series of predetermined contact timings, and pressing the caps against the liquid ejecting head, wherein the caps are symmetrically arranged in an arrangement direction that is parallel with the nozzle opening plane with a symmetry axis perpendicular to the arrangement direction, and wherein at least two caps are brought into contact with the liquid ejecting head at different contact timings, and wherein caps that are arranged symmetrically with respect to the symmetry axis are brought into contact with the liquid ejecting head at the same contact timing.

A third aspect of the present invention is a capping apparatus capable of capping a plurality of nozzle openings that are symmetrically arranged in an arrangement direction in a nozzle opening plane of a liquid ejecting head. The capping apparatus comprises a cap array that has 3 or more caps arranged so as to correspond with the nozzle openings, the caps being capable of moving in a cap moving direction, contacting the liquid ejecting head, and enclosing the nozzle openings, a cap moving unit that is capable of performing a capping operation for each nozzle opening wherein the caps are moved toward the liquid ejecting head in the cap moving direction, brought into contact with the liquid ejecting head at a series of at least two predetermined contact timings, and pressed against the liquid ejecting head, a driving source capable of supplying a driving force to move the caps toward the cap moving unit, wherein each group of caps located an equal distance from the symmetry axis are brought into contact with the liquid ejecting head at the same contact timing.

With this configuration, a capping operation is performed for each of the caps such that at least two caps are brought into contact with the fluid ejecting head at different times. Accordingly, the load on the driving source that occurs when the caps come into contact with the fluid ejecting head is reduced, when compared to configurations where all of the caps are brought into contact with the fluid ejecting head at the same time. Therefore, it is possible to suppress the driving source from stopping due to an excessive load being placed on the driving source at the time of contact. As a result, the caps can be appropriately brought into contact with and pressed against the fluid ejecting head, and a sufficient capping process can be performed.

### BRIEF DESCRIPTION OF THE DRAWINGS

The invention will be described with reference to the accompanying drawings, wherein like members reference like elements.

FIG. 1 is a perspective view illustrating a printer which serves as an example of a liquid ejecting apparatus;

FIG. 2 is a perspective view showing the outline of a maintenance unit;

FIG. 3 is a plan view illustrating the configuration of a maintenance unit;

FIG. 4 is a plan view illustrating the configuration of a maintenance unit;

FIG. 5 is a perspective view illustrating the configuration of a driving mechanism of a slider;

FIGS. 6-8 are side views illustrating the configuration of a driving mechanism of a slider;

FIG. 9 is a block diagram showing a mechanism capable of supplying a driving force to a cam mechanism;

FIG. 10 is a side view illustrating a slider in a standby state;

FIG. 11 is a side view illustrating a slider in a flushing state;

FIG. 12 is a side view illustrating a slider in a capping state;

FIG. 13 is a diagram showing the relationship between a recording head and a cap according to an embodiment of the invention;

FIG. 14 is a diagram showing the configuration of a cam provided in each cam mechanism;

FIG. 15 is a diagram showing a capping operation according to an embodiment of the invention; and

FIG. 16 is a diagram showing the configuration of a cam according to a second embodiment of the invention.

### DESCRIPTION OF EXEMPLARY EMBODIMENTS

Prior to describing embodiments of the invention, the basic configuration of a liquid ejecting apparatus, to which the invention is applied, will be described.

Thereafter, the embodiments of the invention will be described.

### Basic Configuration

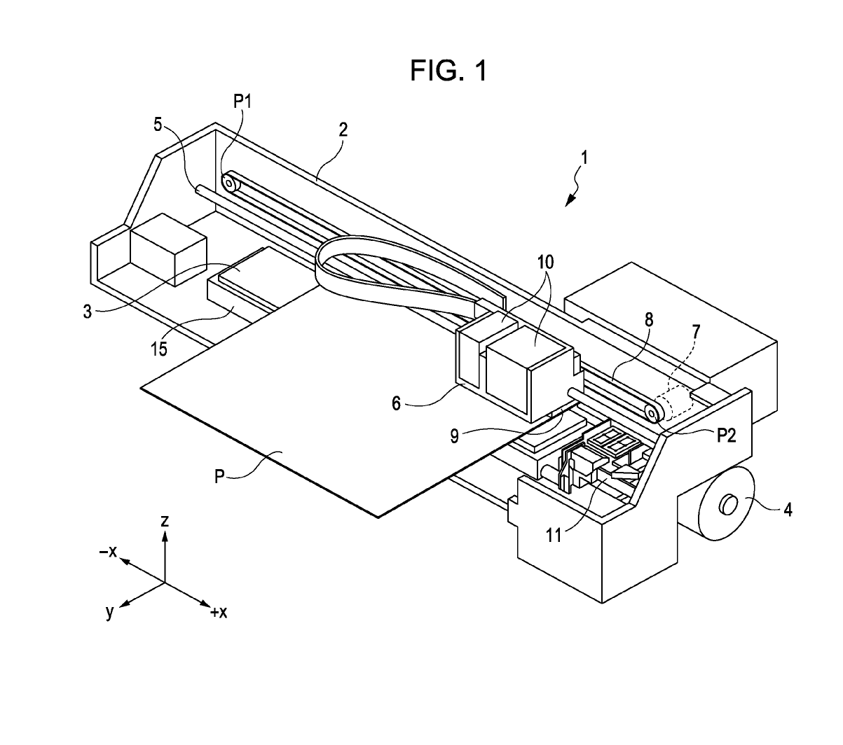

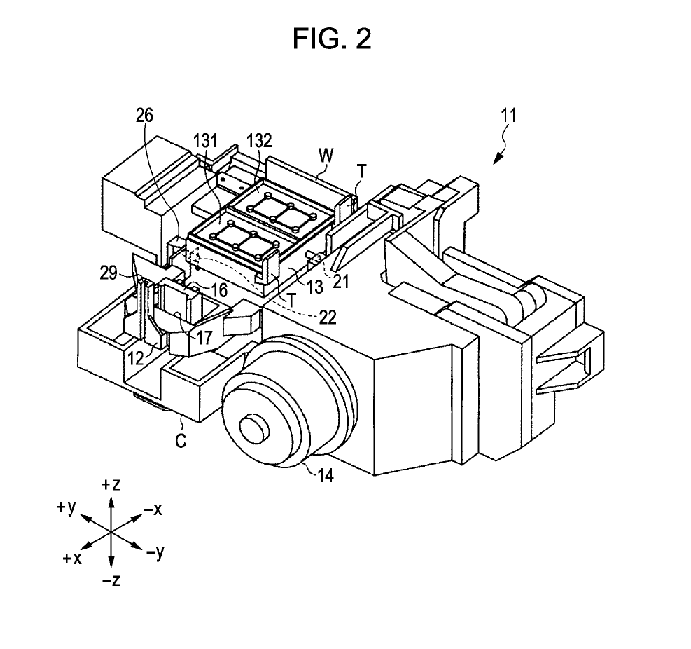

FIG. 1 is a perspective view showing the outline of a printer 1, which servings as an example of a liquid ejecting apparatus. FIG. 2 is a perspective view showing the outline of a maintenance unit. As shown in FIG. 1, the printer 1 includes a frame 2 having a substantially rectangular parallelepiped shape. In the frame 2, a platen 3 is provided in the longitudinal direction (x direction). A recording paper P is fed onto a platen 3 by a paper feed mechanism (not shown) which includes a paper feed motor 4.

In the frame 2, a guide member 5 is provided to be parallel with the platen 3. A carriage 6 is inserted in the frame 2 and is supported by the guide member 5 so as to move along the guide member 5. In addition, a carriage motor 7 is attached to the frame 2. The carriage 6 is in drivable connection with the carriage motor 7 via a timing belt 8, which is stretched between a pair of pulleys P1 and P2. In this configuration, when the carriage motor 7 is driven, its driving force is transferred to the carriage 6 through the timing belt 8. The carriage 6 receives the driving force and is guided by the guide member 5 to reciprocate in a main scanning direction (+x direction and −x direction) in parallel with the platen 3.

On a lower surface of the carriage 6, a recording head 9 is provided which serves as a liquid ejecting head. The recording head 9 has a planar nozzle forming surface. In the nozzle forming surface, a plurality of nozzles (not shown) are formed to face the recording paper P. That is, the nozzle forming surface corresponds to the nozzle opening plane of the invention. The nozzles are formed in the nozzle opening plane.

As shown in FIG. 1, an ink cartridge 10 serving as a liquid storage unit is detachably mounted in the carriage 6. The ink cartridge 10 is divided into a plurality of storage chambers, and in each of the storage chambers, ink serving as a liquid (for example, pigment ink and reactive ink) is stored. That is, the printer 1 of FIG. 1 is called on-carriage type of printer. Ink stored in the ink cartridge 10 is supplied to the corresponding nozzle of the recording head 9. With this configuration, when the ink cartridge 10 is mounted in the carriage 6, ink stored in the ink cartridge 10 flows into the recording head 9. Then, ink flowing into the recording head 9 is pressurized by a piezoelectric element (not shown), and ejected from the nozzle openings of the nozzles toward the recording paper P in the form of ink droplets.

The recording head 9 is driven to discharge reactive ink after black ink or color ink (pigment ink) is discharged. The reactive ink sticks to the color ink on the recording paper P in order to coagulate with the color ink, and thereby increase color reproduction and gloss of the color ink. The recording head 9 may also be driven to discharge the reactive ink onto a paper portion on which the black ink and the color ink have not been discharged, in order to increase the gloss of the paper.

In the printer 1, the region where ink droplets are discharged onto the recording paper P while the carriage 6 reciprocates is referred to as a printing region or ejecting region. In addition to the printing region, the printer 1 also includes a non-printing region where the nozzles are capped when the printer is not performing a printing operation. A maintenance unit 11 is provided in the non-printing region. The maintenance unit 11 periodically performs maintenance operations on the recording head 9 in order to ensure that the nozzles are able to properly discharge the liquid during the printing process.

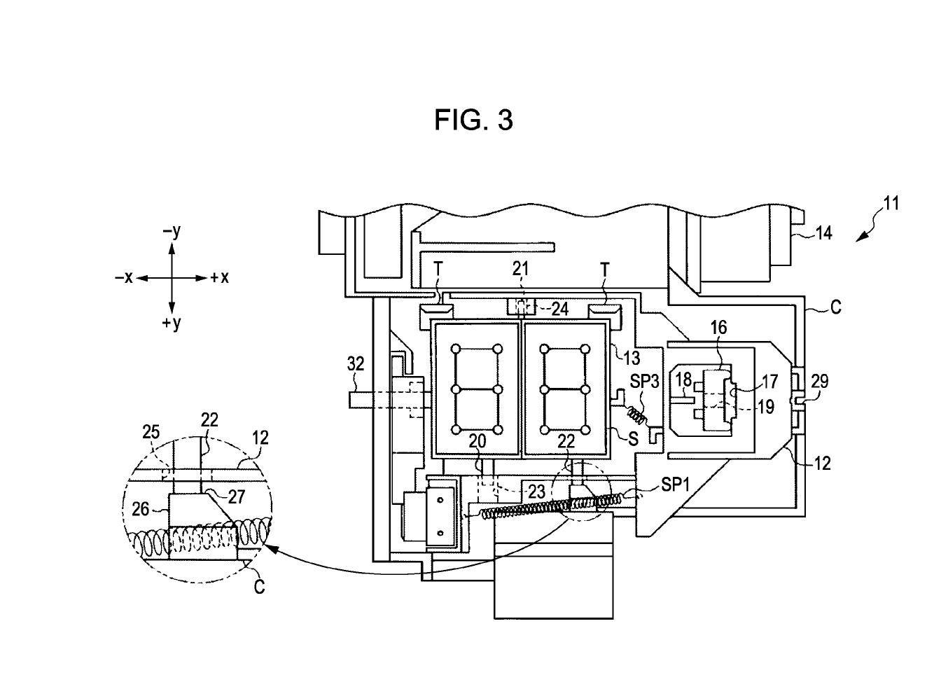

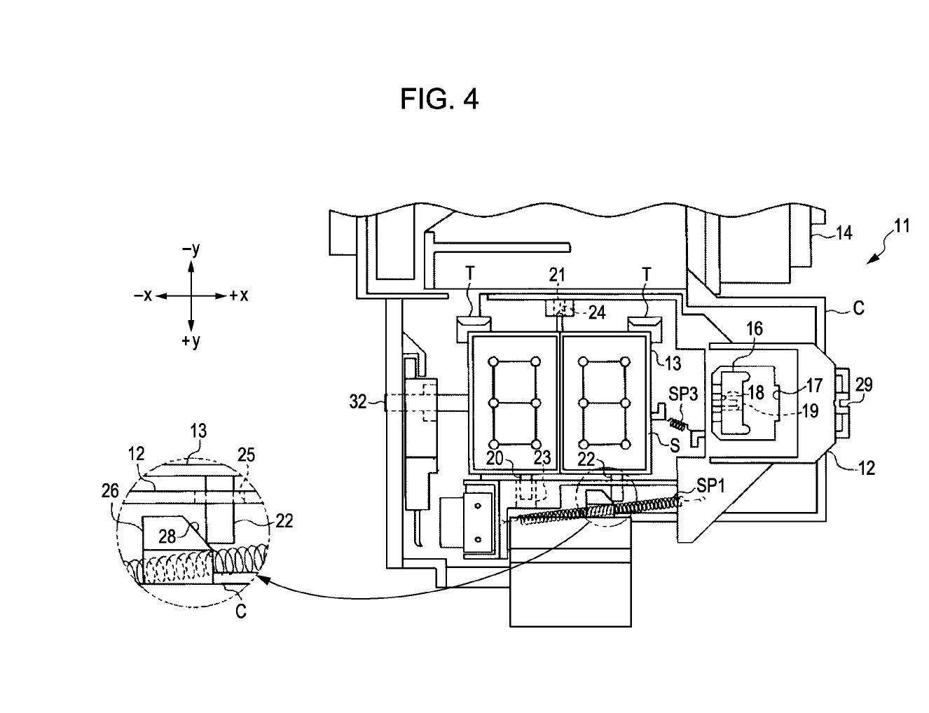

As shown in FIG. 2, a slider 12 is attached to a main body case C of the maintenance unit 11 through a spring member SP1 (shown in FIGS. 3 and 4) so as to reciprocate in the left-to-right direction (+x direction and −x direction). A cap member 13 having a substantially rectangular parallelepiped shape is provided in the slider 12 to cap the nozzles of the recording head 9. By a moving mechanism described below, the maintenance unit 11 moves the cap member 13 in a horizontal direction so as to be positioned directly below the recording head 9 or moves the cap member 13 in an vertical direction to be in close contact with the recording head 9, in order to cap the nozzles of the recording head 9.

The inside of the cap member 13 is divided into two sections, in which absorbers 131 and 132 are correspondingly placed. A waste ink tank (not shown), is provided below the platen 3 shown in FIG. 1 and is connected to the bottom of the cap member 13 through two tubes (not shown). The two tubes communicate with the sections of the cap member 13 and a suction pump (not shown). The inside of the waste ink tank is divided into two sections, which are connected to two sections of the cap member.

With the above-described configuration, the pigment ink and the reactive ink stored in the ink cartridge 10 can be separately absorbed by the absorbers 131 and 132, and discarded in the waste ink tank during a cleaning operation.

As shown in FIG. 2, the maintenance unit 11 has a wiper member W for cleaning away any ink stuck to the nozzle forming surface of the recording head 9. The wiper member W is provided to be moved by a driving mechanism (not shown) housed in the main body case C.

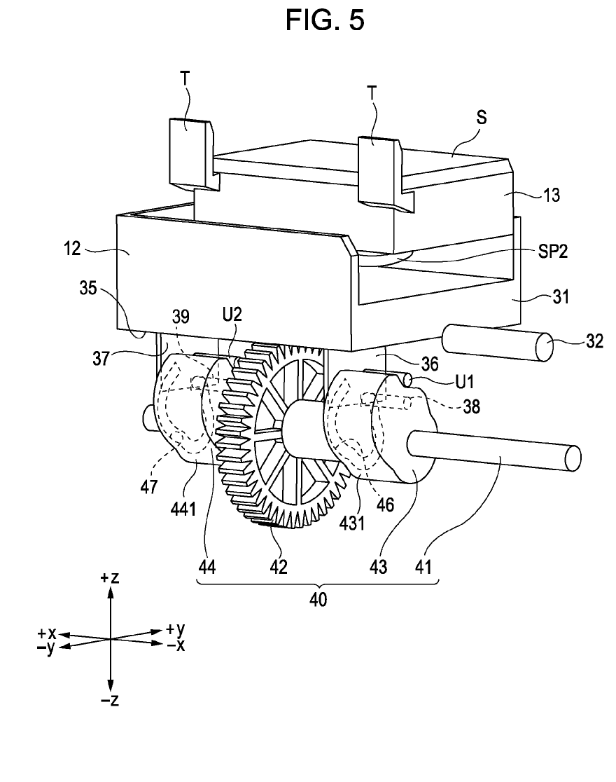

Next, the configuration of the maintenance unit 11 will be described with reference to FIGS. 3 to 8. FIGS. 3 and 4 are plan views illustrating the configuration of the maintenance unit 11. FIG. 5 is a perspective view illustrating the configuration of a driving mechanism of the slider 12.

As shown in FIG. 3, the maintenance unit 11 has a slider guide 16 that guides the slider 12 toward the main body case C. The slider guide 16 is inserted into an insertion slot 17 of the slider 12. In addition, in the slider 12, a support rod 18 is formed in the insertion slot 17 to extend in the right direction (+x direction). A support groove 19 is formed in the slider guide 16 so as to correspond to the support rod 18. The support rod 18 is inserted into and supported by the support groove 19. In this case, the support groove 19 is formed to pass through the slider guide 16, such that the support rod 18 can move along the x-axis in the horizontal direction. Furthermore, the support groove 19 is longitudinally formed such that support rod 18 can move in the vertical direction (+z direction and −z direction). The support groove 19 comes into contact with the support rod 18 at its upper end so as to regulate the movement of the support rod 18 in the vertical direction (+z direction).

With this configuration, the slider 12 can move in the vertical direction (+z direction and −z direction) and the horizontal direction (+x direction and −x direction) with respect to the main body case C.

As described above, the slider 12 is attached to the main body case C through the spring member SP1. Accordingly, the slider 12 is pulled in the left direction (−x direction) with respect to the main body case C, such that if no force acts on the slider 12, as shown in FIG. 3, the insertion slot 17 of the slider 12 is in contact with a right end of the slider guide 16 in the main body case C. This state is referred to as a reference position.

As shown in FIG. 5, the cap member 13 is attached to the slider 12 through a spring member SP2. As shown in FIG. 3 or FIG. 4, the cap member 13 has a flexible seal member S that comes into contact with the recording head 9, and a claw portion T that comes into contact with the recording head 9 which serves as a support member. The cap member 13 further has a support rod 20 that extends in a front direction (+y direction), a support rod 21 that extends in a back direction (−y direction), and a positioning rod 22 that extends in the front direction (+y direction) which serves as a positioning unit.

Meanwhile, as shown in FIG. 3 or 4, in the slider 12, support grooves 23 and 24 and a guide groove 25 serving as a guide unit are formed to correspond to the support rods 20 and 21 and the positioning rod 22. The support rods 20 and 21 and the positioning rod 22 are inserted into and supported by the support grooves 23 and 24 and the guide groove 25, respectively. The support grooves 23 and 24 and the guide groove 25 are longitudinally formed, such that the support rods 20 and 21 and the positioning rod 22 can move along the z-axis, respectively. The support grooves 23 and 24 and the guide groove 25 come into contact with the support rods 20 and 21 and the positioning rod 22 at their upper ends, respectively, so as to regulate the movement in the +z direction. In addition, the movements of the support rods 20 and 21 and the positioning rod 22 along the x-axis are regulated by the support grooves 23 and 24 and the guide groove 25, respectively. The depths of the support grooves 23 and 24 and the guide groove 25 are formed such that, when the cap member 13 moves along the y-axis, the support rods 20 and 21 and the positioning rod 22 are kept therein the support grooves 23 and 24, respectively.

With this configuration, the cap member 13 can move along the z-axis with respect to the slider 12. In addition, the cap member 13 is urged in the +z direction by the spring member SP2, while the movement of the cap member 13 in the +z direction is regulated by the support rods 20 and 21 and the positioning rod 22. Accordingly, when the cap member 13 is located as far as possible in the +z direction with respect to the slider 12 and is pressed in the −z direction, the cap member 13 moves in the −z direction according to the pressure.

As shown in FIG. 3 or 4, a spring member SP3 is attached between the slider 12 and a right surface of the cap member 13. The spring member SP3 applies a pressure on the cap member 13 that causes the cap member 13 to move toward the slider 12 in the +x direction and +y direction with respect to the slider 12. The movement of the cap member 13 along the x-axis with respect to the slider 12 is regulated by the support grooves 23 and 24, as described above. Therefore, the cap member 13 is forced in the +y direction with respect to the slider 12.

The main body case C has, as shown in FIG. 3 or 4, a protrusion 26 having a substantially trapezoidal shape as a guide portion. The protrusion 26 is formed so as to protrude from the main body case C in the −y direction. The protrusion 26 faces and comes into contact with the positioning rod 22 of the cap member 13.

As shown in FIG. 3, when the slider 12 is located at the reference position, the positioning rod 22 of the cap member 13 comes into contact with an end portion 27 of the protrusion 26. In this state, the cap member 13 is supported by the protrusion 26 through the positioning rod 22, such that the movement of the cap member 13 is regulated.

When the slider 12 moves from the reference position in the +x direction, the cap member 13 attached to the slider 12 is forced in the +y direction with respect to the slider 12 by the spring member SP3. Accordingly, the positioning rod 22 moves in a +x and +y direction along a slope portion 28 of the protrusion 26. Then, as shown in FIG. 4, the positioning rod 22 is supported by the slope portion 28 of the protrusion 26. At this time, the cap member 13 is stopped in a set position, wherein the cap member 13 is slightly moved further in the +y direction than in the state shown in FIG. 3.

With this configuration, when the recording head 9 comes into contact with a contact portion 29 formed to extend from the slider 12, and the slider 12 is pressed in the +x direction, the slider 12 moves, and the cap member 13 moves to the set position. At this time, when the cap member 13 is in the set position, the claw portion T of the cap member 13 moves in the +y direction and comes into contact with the recording head 9. That is, the set position refers to a position where the cap member 13 directly faces the nozzles of the recording head 9. In contrast, the reference position refers to a position where the cap member 13 is retracted from the way of the recording head 9 in the main scanning direction.

The guide groove 25 provided in the slider 12 is formed to have a size that is approximately 1.2 times larger than the positioning rod 22 of the cap member 13. Therefore, abrasion occurring when the positioning rod 22 comes into contact with the guide groove 25 can be reduced. In addition, the movement of the cap member 13 along the y-axis can be prevented from deteriorating due to the abrasion.

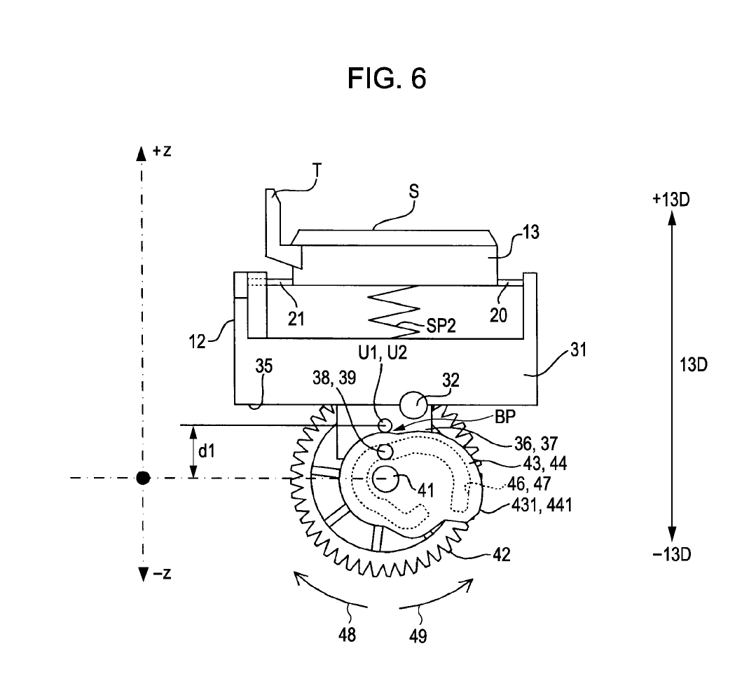

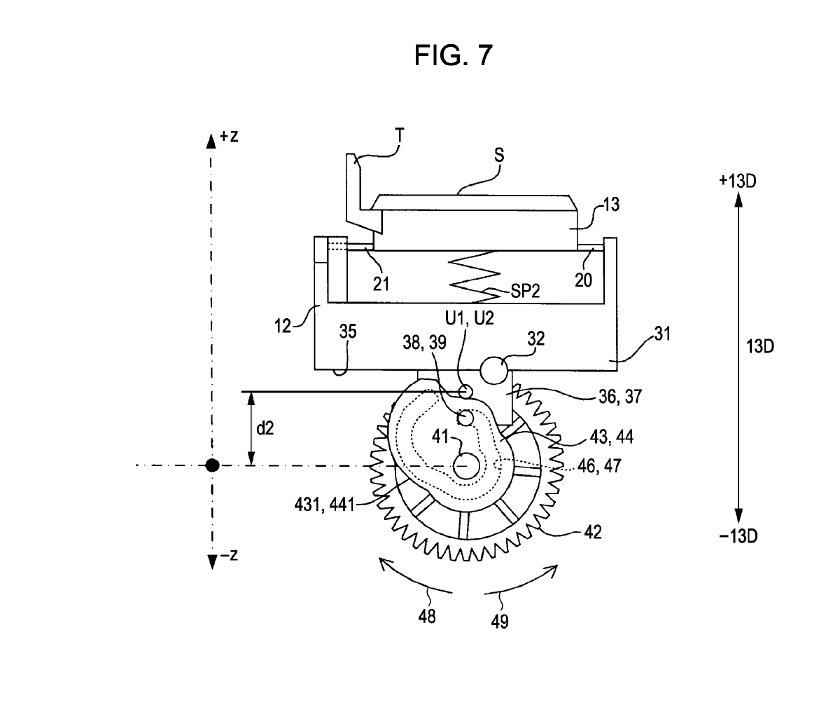

Next, the configuration of a driving mechanism of the slider 12 will be described with reference to FIGS. 5-8. FIGS. 6 to 8 are side views illustrating the configuration of a cam mechanism for driving the slider 12. FIGS. 6 to 8 are side views as the slider 12. FIG. 9 is a block diagram showing a mechanism for supplying a driving force to the cam mechanism.

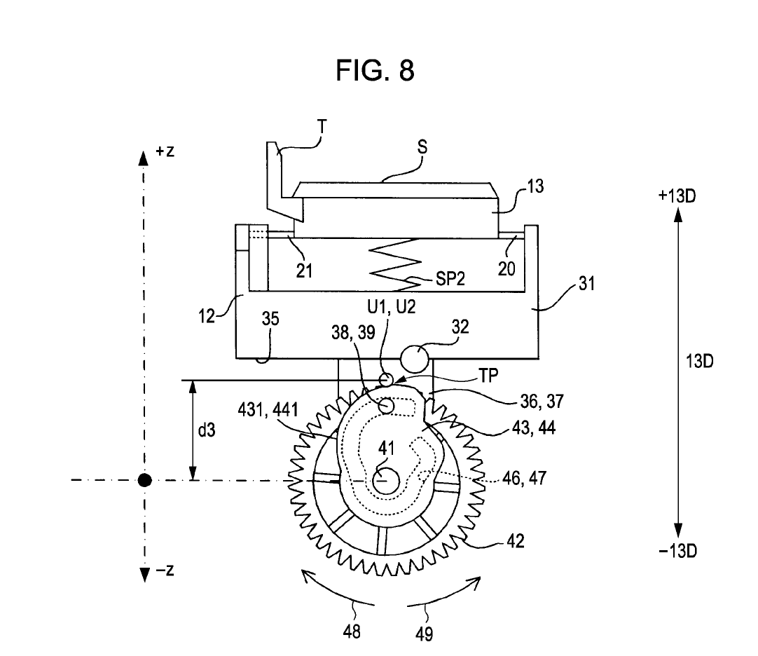

As shown in FIG. 5, a shaft 32 is formed at a lower portion of the side surface 31 of the slider 12 so as to extend in the −x direction. The shaft 32 is inserted into and supported by a guide groove 34 (see FIG. 10) that is formed in a side surface 33 (see FIG. 10) of the main body case C along the z-axis. The guide groove 34 serves as a guide unit for the shaft 32. As shown in FIG. 4, the shaft 32 has a sufficient length to allow it to remain in the guide groove 34 when the slider 12 moves along the x-axis.

Two plate portions 36 and 37 are formed at the bottom 35 of the slider 12. As shown in FIG. 5, slide shafts 38 and 39 and contact shafts U1 and U2 are formed in the plate portions 36 and 37 so as to extend in the −x direction.

As shown in FIG. 5, a cam mechanism 40 is provided below the slider 12 in the main body case C in order to serve as a driving mechanism. The cam mechanism 40 includes a shaft 41, a gear 42, and cams 43 and 44. The gear 42 is fixed at the center of the shaft 41. The cams 43 and 44 are fixed at both ends of the shaft 41 with the gear 42 as the center, respectively. Accordingly, when the gear 42 rotates due to a driving force, the cams 43 and 44 also rotate in the same direction. The cam mechanism 40 is configured such that both ends of the shaft 41 are inserted into and rotatably supported by a support hole 45 (see FIG. 10) provided in the side surface of the main body case C and a support hole (not shown) provided in the main body case C, respectively. With this configuration, the cam mechanism 40 is capable of rotating around the shaft 41. In addition, as shown in FIG. 5, the cam mechanism 40 is attached to the slider 12 by inserting slide shafts 38 and 39 of the plate portions 36 and 37 into corresponding slide grooves 46 and 47, which are formed in the cams 43 and 44, respectively. At this time, the contact shafts U1 and U2 come into slidable contact with a side surface 431 of the cam 43 and a side surface 441 of the cam 44, respectively.

Accordingly, when the cam mechanism 40 rotates around the shaft 41, since the cams 43 and 44 rotate, the slide shafts 38 and 39 slide along the slide grooves 46 and 47. At this time, the contact shafts U1 and U2 come into slidable contact with and are supported by the side surfaces 431 and 441 of the cams 43 and 44. Then, the shaft 41 and the contact shafts U1 and U2 are moved closer or further from each other, depending on the rotation of the shaft 41. That is, as described above, since the shaft 41 of the cam mechanism 40 is supported by the main body case C, the slider 12 moves along the z-axis with respect to the main body case C while guiding the shaft 32 in the guide groove 34 of the main body case C.

The gear 42 of the cam mechanism 40 is driven by a driving force, which is supplied from a driving motor 402 through a driving mechanism 401. Moreover, the driving motor 402 can rotate forward and backward. Accordingly, for example, when the slide grooves 46 and 47 of the cams 43 and 44, and the slide shafts 38 and 39 are in the state shown in FIG. 6, and the relative distance between the shaft 41 and the contact shafts U1 and U2 is d1, if the driving motor 402 rotates forward, the gear 42 rotates in a clockwise direction, shown by arrow 48, due to the driving force from the driving motor 402. Then, the slide shafts 38 and 39 slide and are guided in the slide grooves 46 and 47, and move in the slide grooves 46 and 47 to a position shown in FIG. 7. At this time, the contact shafts U1 and U2 slide and are supported along the side surfaces 431 and 441 of the cams 43 and 44. Accordingly, the relative distance between the shaft 41 and the contact shafts U1 and U2 becomes the distance d2. Thus, when the relative distance between the shaft 41 and the contact shafts U1 and U2 changes from d1 to d2, the slider 12 and the cap member 13, which is connected to the slider 12 through the spring member SP2, move in the cap moving direction +13D. Moreover, in the cap moving direction 13D, an upward direction in FIGS. 6 to 8 is referred to as a cap moving direction +13D, and a downward direction in FIGS. 6 to 8 is referred to as a cap moving direction −13D.

When the positional relationship between the slide grooves 46 and 47 and the slide shafts 38 and 39 is as shown in FIG. 6 (wherein the relative distance between the shaft 41 and the contact shafts U1 and U2 is d1), and the driving motor 402 rotates backward, the gear 42 rotates in a counterclockwise direction, as shown by arrow 49 due to the driving force from the driving motor 402. Then, the slide shafts 38 and 39 slide and are guided in the slide grooves 46 and 47, where the shafts 28 and 29 move to the position shown in FIG. 8. At this time, the contact shafts U1 and U2 slide and are supported along the side surfaces 431 and 441 of the cams 43 and 44. Accordingly, the relative distance between the shaft 41 and the contact shafts U1 and U2 becomes a relative distance d3. According to the change from the relative distance d1 to the relative distance d3, the slider 12 and the cap member 13, which is connected to the slider 12 through the spring member SP2, move in the cap moving direction +13D.

The dimensional relationship of the relative distances d1, d2, and d3 is as follows: relative distance d1<relative distance d2<relative distance d3. Moreover, the state shown in FIG. 6, with a relative distance d1, is referred to as a standby state. The state shown in FIG. 7, with the relative distance d2, is referred to as a flushing state, and the state shown in FIG. 8 is referred to as a capping state, with a relative distance d3. The driving motor 402 rotates forward, backward, and stops according to a control signal from a control circuit (not shown) provided in the printer 1, in order to maintain the standby state, the flushing state, and the capping state. That is, as the cams 43 and 44 rotate, the relative distance changes, and the cap member 13 moves in the cap moving direction 13D. Therefore, according to the above-described configuration, the cap member 13 is moved to a position corresponding to each state by controlling the rotation of the cams 43 and 44.

In this specification, as shown in FIG. 6, the position on the side surfaces 431 and 441 of the cams 43 and 44, with which the contact shafts U1 and U2 respectively come into contact with in the standby state are particularly referred to as a bottom point BP. In addition, in this specification, a position on the side surfaces 431 and 441 of the cams 43 and 44 shown in FIG. 8, with which the contact shafts U1 and U2 respectively come into contact with in the capping state is referred to as a top point TP.

When the slider 12 is in the standby state, as shown in FIG. 6, if the slider 12 moves to the flushing state shown in FIG. 7 in the main body case C, the wiper member W moves from the inside of the main body case C, and is positioned so as to come into contact with the recording head 9.

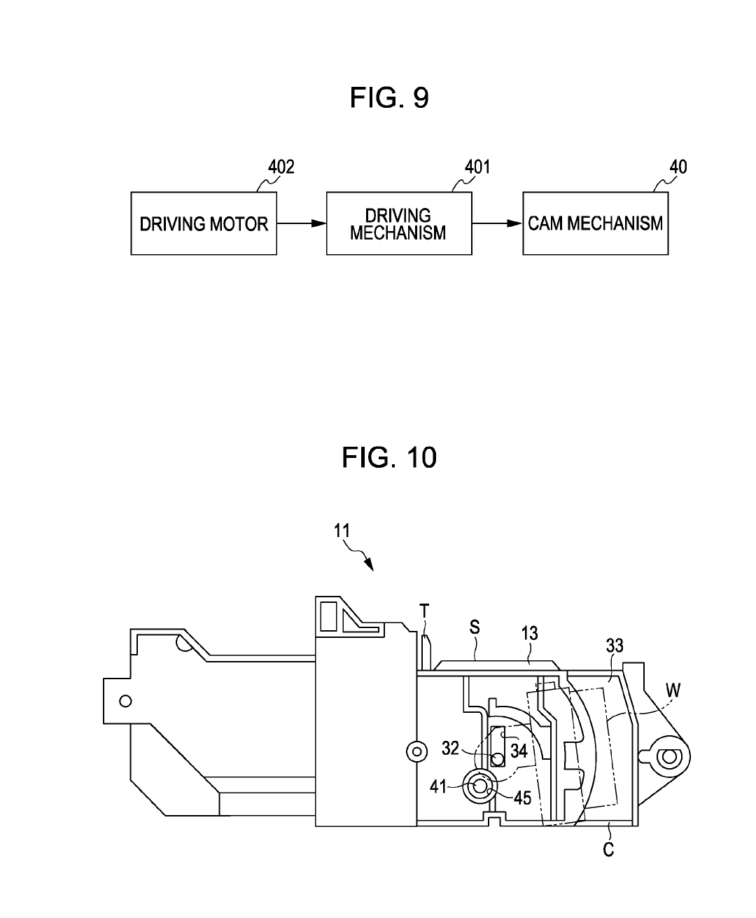

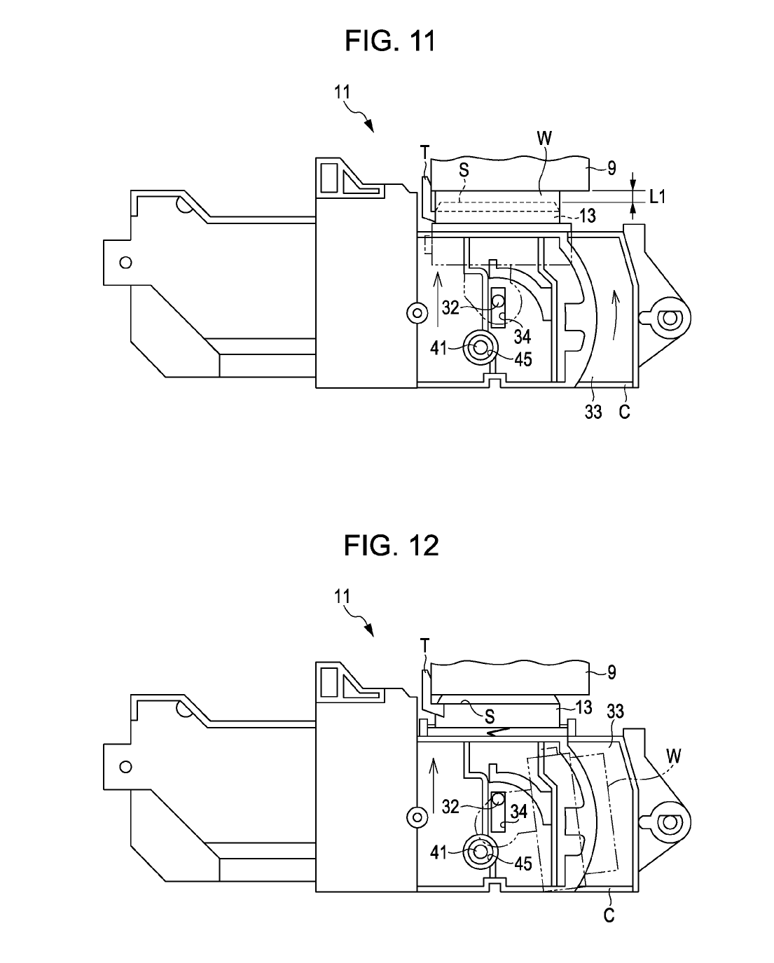

Next, the operation of the maintenance unit 11 having the above-described configuration will be described with reference to FIGS. 10 to 12. FIG. 10 is a side view illustrating the standby state of the slider 12. FIG. 11 is a side view illustrating the flushing state of the slider 12. FIG. 12 is a side view illustrating the capping state of the slider 12.

As shown in FIG. 10, when the slider 12 is in the standby state, and the relative distance is d1, as shown in FIG. 3, the maintenance unit 11 places the slider 12 at the reference position.

When the printer 1 shown in FIG. 1 performs a flushing operation to discharge ink from the nozzles of the recording head 9 to the cap member 13, the carriage 6 is moved to the non-printing region, and the recording head 9 is brought into contact with the contact portion 29 of the slider 12. Then, if the recording head 9 comes into contact with the contact portion 29, as shown in FIG. 4, the slider 12 moves to the set position. Accordingly, the claw portion T moves in the +y direction, and comes into contact with the recording head 9 in order to support the recording head 9. Therefore, the cap member 13 can directly face the recording head 9.

At this time, when bringing the recording head 9 into contact with the contact portion 29 of the slider 12, the printer 1 moves the slider 12 from the standby state to the flushing state. Accordingly, the wiper member W moves from the inside of the main body case C to a position where it is capable of coming into contact with the recording head 9. Then, if the recording head 9 passes over the wiper member W so as to come into contact with the contact portion 29 of the slider 12, any ink sticking to the nozzle forming surface of the recording head 9 is cleaned off. Next, when the slider 12 moves to the flushing state, the driving motor 402 is stopped, and as shown in FIG. 11, the flushing state is maintained. At this time, the cap member 13 faces the recording head 9 with a gap L1 between the cap member 13 and the recording head 9. Then, the printer 1 performs the flushing operation in order to perform a maintenance operation on the nozzles of the recording head 9.

When the recording head 9 is capped in this state, the printer 1 moves the slider 12 from the flushing state to the standby state, and then to the capping state. Accordingly, as shown in FIG. 12, since the slider 12 further moves in the +z direction, the seal member S of the cap member 13 comes into contact with the recording head 9 to cap the nozzle forming surface, thereby preventing ink at the nozzle from drying.

In a state in which the cap member 13 caps the recording head 9, if the suction pump is driven, a cleaning operation can be performed to remove any clogged ink, air bubbles, dust, or other cause of nozzle clogging in the recording head 9 through the cap member 13. The foregoing description is given for basic configuration of a liquid ejecting apparatus, to which the invention is applied. Next, the embodiments of the invention will be described.

### First Embodiment

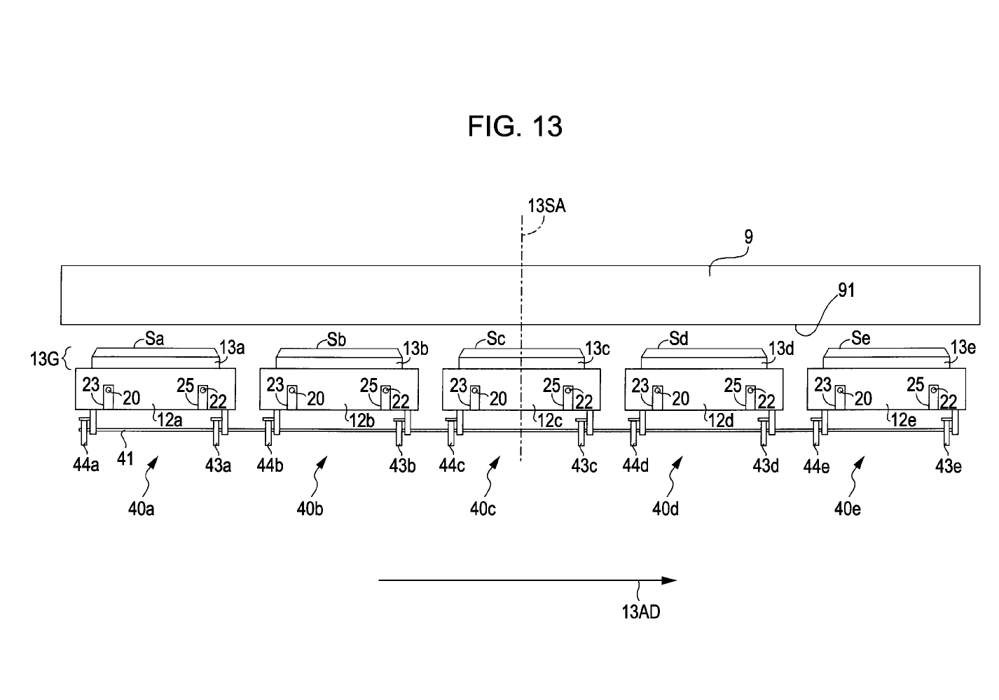

FIG. 13 is a diagram showing the relationship between a recording head and a cap in a first embodiment of the invention. In the first embodiment, as shown in FIG. 13, a cap array 13G having Q (where Q is an integer of 3 or more) cap members 13 is arranged to face a nozzle forming surface 91. Specifically, five cap members 13a to 13e are arranged to face the nozzle forming surface 91 of the recording head 9. For each of the cap members 13a-13e, a slider 12 and a cam mechanism 40 are provided. The slider 12 and the cam mechanism 40 provided for each of the cap members 13a-13e have the same configuration as those shown in FIGS. 6 to 8. In this specification, to clearly state which of cap members 13a-13e each member corresponds to, the alphabetic character of the corresponding cap member 13 is appended to the end of the reference numeral of each member. That is, the cam mechanisms 40, which correspond to each of the cap members 13a to 13e, are referred to as cam mechanisms 40a-40e, respectively. In addition, the sliders 12, which are correspond to the cap members 13a-13e, are referred to as sliders 12a-12e, respectively.

As shown in FIG. 13, the five cap members 13a-13e are arranged symmetrically in an arrangement direction 13AD that is parallel with the nozzle forming surface 91 with a symmetry axis 13SA that is perpendicular to the nozzle forming surface 91 interposed there between. That is, the cap member 13a and the cap member 13e are arranged so as to be symmetric with respect to the symmetry axis 13SA, and the cap member 13b and the cap member 13d are arranged symmetrically with respect to the symmetry axis 13SA. In addition, the cam mechanisms 40a-40e all use the same shaft 41. The shaft 41 rotates due to the driving force from the driving motor 402. Accordingly, as the driving motor 402 rotates, the cams 43 and 44 of each of the cam mechanisms 40a-40e rotate.

Referring to FIG. 13, each of the cap members 13a-13e are in the standby state, and are spaced from the nozzle forming surface 91 of the recording head 9. Then, if the capping operation is carried out, each of the cap members 13a-13e changes from the standby state to the capping state. The details of the capping operation will be described below.

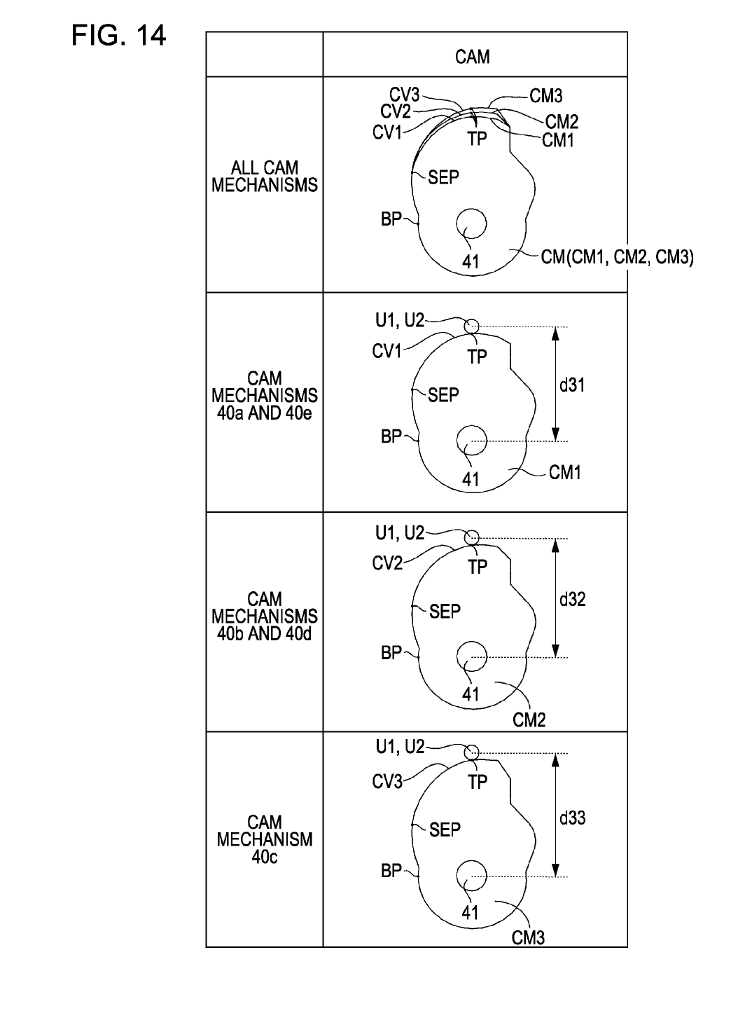

FIG. 14 is a diagram showing the configuration of the cams provided in each cam mechanism. In the first embodiment, the cam mechanisms 40a-40e have the same configurations, except for some variation in the cams 43 and 44 of each cam mechanism 40a-40e. In addition, the sliders 12 that correspond to the cap members 13a-13e have the same configuration. The cam mechanisms 40a-40e are arranged symmetrically with respect to the symmetry axis 13SA.

A cam CM1 shown in the row entitled “CAM MECHANISMS 40a AND 40e” of FIG. 14 is a diagram of a cam that is provided in the cam mechanisms 40a and 40e. That is, cam CM1 corresponds to cam 43a, 44a, 43e, or 44e. A curved surface CV1 is formed at the side surface of the cam CM1, which extends from the bottom point BP to the top point TP. The relative distance between the contact shafts U1 and U2, which come into contact with the top point TP, and the shaft 41 is a relative distance d31. That is, in each of the cam mechanisms 40a and 40e, the relative distance in the capping state is a relative distance d31.

The next row of FIG. 14 entitled “CAM MECHANISMS 40b AND 40d” illustrates a cam CM2 that is used in each of the cam mechanisms 40b and 40d. That is, the cam CM2 corresponds to cam 43b, 44b, 43d, or 44d. A curved surface CV2 is formed at the side surface of the cam CM2 which extends from the bottom point BP to the top point TP. In addition, the relative distance between the contact shafts U1 and U2, which come into contact with the top point TP, and the shaft 41 is a relative distance d32. That is, in the cam mechanisms 40b and 40d, the relative distance in the capping state is a relative distance d32.

The fourth row of the diagram shown in FIG. 14 entitled “CAM MECHANISM 40c” of FIG. 14 illustrates a cam CM3 that is provided in the cam mechanism 40c. That is, the cam CM3 corresponds to the cam 43c or 44c. As shown in that row, a curved surface CV3 is formed in the side surface of the cam CM3 from the bottom point BP to the top point TP. In addition, the relative distance between the contact shafts U1 and U2, which come into contact with the top point TP, and the shaft 41 is a relative distance d33. That is, in the cam mechanism 40c, the relative distance in the capping state becomes the relative distance d33.

The top row of FIG. 14, entitled “ALL CAM MECHANISMS” illustrates all the cams CM1, CM2, and CM3 in an overlapping manner. As shown in that row, the cams CM1 to CM3 have differently shaped side surfaces from the bottom point BP to the top point TP. That is, the shapes of curved surfaces CV1 to CV3 are different from each other. Specifically, the shapes of the curved surfaces CV1 to CV3 differ starting at a separation point SEP. Here, the separation point SEP is a point that, for each of the curved surfaces CV1 to CV3, is provided between the bottom point BP and the top point TP. That is, from the separation point SEP to the top point TP of the cams CM1, CM2, and CM3, the curved surfaces CV1 to CV3 curve with an increasing radius toward in that respective order. In addition, the dimensional relationship of the relative distances d31 to d33 corresponding to the cams CM1 to CM3 is as follows: relative distance d33>relative distance d32>relative distance d31.

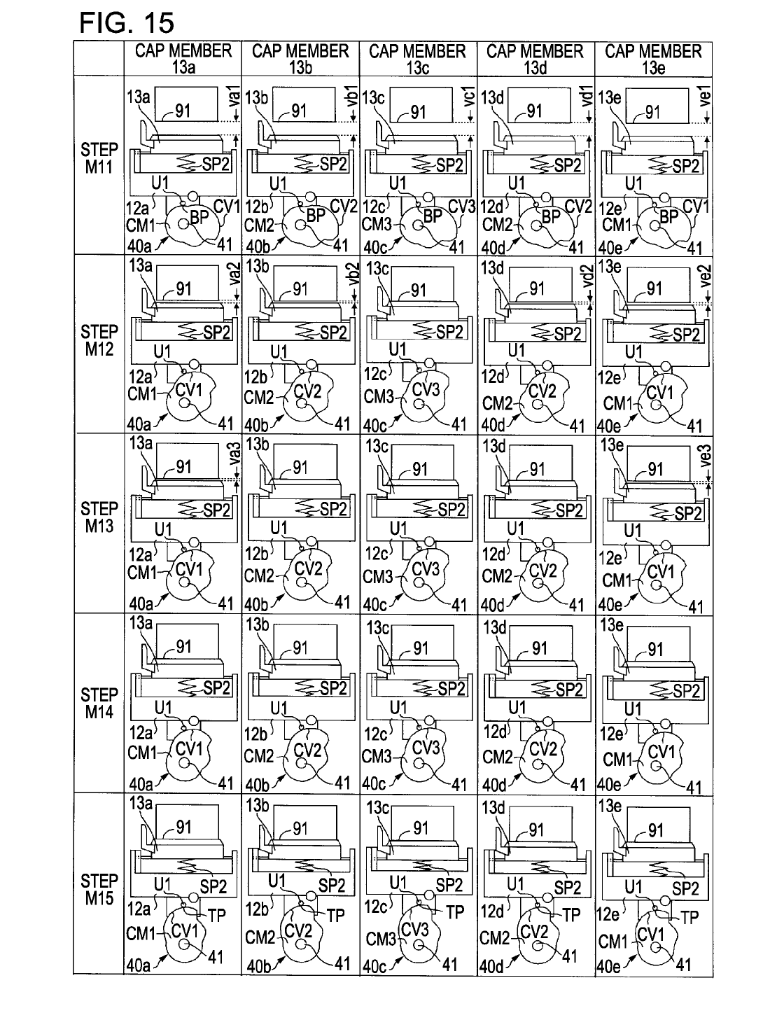

FIG. 15 is a diagram showing a capping operation according to a first embodiment of the invention. Here, the capping operation is an operation wherein the cap member 13 is moved toward the recording head 9 in the cap moving direction 13D so as to be brought into contact with the recording head 9, and to press the cap member 13 against the recording head 9. Then, in the first embodiment, the capping operation is carried out for all of the cap members 13a-13e.

In step M11, the contact shafts U1 and U2 come into contact with the cams CM1 to CM3 of the cam mechanisms 40a-40e at the bottom point BP. Accordingly, the cap members 13a-13e are each spaced from the nozzle forming surface 91a distance va1-ve1, respectively. At step M11, the gaps va1-ve1 are identical. Because, the configuration and operation of the contact shaft U1 and the contact shaft U2 is the same, the description and illustration of the configuration and operation of the contact shafts U1 and U2 will be given using contact shaft U1 as an example.

At the end of step M11, all the cap members 13a-13e are separated from the nozzle forming surface 91 at a predetermined distance va1-ve1. At the beginning of the capping operation, however, the driving motor 402 starts to rotate the shaft 41, and the shaft 41 and the cams CM1-CM3 fixed to the shaft 41 start to rotate in the counterclockwise direction.

As the cam CM1 rotates, the contact shafts U1 of the sliders 12a and 12e move in the cap moving direction (the upward direction in FIG. 15) along the curved surface CV1 of the cam CM1. As a result, the sliders 12a and 12e move toward the nozzle forming surface 91. In addition, as the sliders 12a-12e move, the cap members 13a and 3e, which are correspondingly connected to the sliders 12a and 12e through the spring member SP2, move toward the nozzle forming surface 91.

Similarly, as the cam CM2 rotates, the contact shafts U1 of the sliders 12b and 12d move in the cap moving direction +13D toward the nozzle forming surface 91 while coming into slidable contact with the curved surface CV2 of the cam CM2. In addition, as the sliders 12b and 12d move, the cap members 13b and 13d, which are correspondingly connected to the sliders 12b and 12d through the spring member SP2, move toward the nozzle forming surface 91.

Furthermore, as the cam CM3 rotates, the contact shaft U1 of the slider 12c moves in the cap moving direction +13D toward the nozzle forming surface 91 while coming into slidable contact with the curved surface CV3 of the cam CM3. As the slider 12c moves, the cap member 13c, which is connected to the slider 12c through the spring member SP2, moves toward the nozzle forming surface 91.

As described above, among the curved surfaces CV1 to CV3, the curved surface CV3 has a position that is the farthest from the shaft 41 and the largest radius. As a result, the contact shaft U1 of the slider 12c is the first to move in the cap moving direction +13D. As a result, in Step M12, the cap member 13c is the first of the five cap members 13a-13e to come into contact with the nozzle forming surface 91. As shown in step M12 of FIG. 15, the cap member 13a is spaced a distance of va2 from the nozzle forming surface 91, while the cap member 13b is spaced at a distance of vb2 from the nozzle forming surface 91. Similarly, the cap member 13d is a distance vd2 from the nozzle forming surface 91, and the cap member 13e is a distance ve2 from the nozzle forming surface 91. Thus, the distances va2 and ve2 are the same, and the distances vb2 and vd2 are the same.

If the cams CM1 to CM3 continue to rotate beyond the state shown in step M12 in the counterclockwise direction, the cap members 13a, 13b, 13d, and 13e move further in the cap moving direction. At this time, the cap member 13c is already in contact with the nozzle forming surface 91, and thus does not move in the cap moving direction +13D any further. Meanwhile, the cam CM3 continues to rotate in the counterclockwise direction, causing the slider 12c to continue to move in the cap moving direction +13D. Accordingly, the slider 12c moves in the cap moving direction +13D against the force of the spring member SP2, which is disposed between the slider 12c and the cap member 13c. As a result, the cap member 13c is pressed against the nozzle forming surface 91 with a force supplied by the spring member SP2.

As described above, from among the curved surfaces CV1 to CV3, the curved surface CV2 passes has a circumference that is second farthest from the shaft 41, and the second largest radius after the curved surface CV3. Accordingly, subsequently to the contact shaft U1 of the slider 12c, the sliders 12b and 12d move in the cap moving direction +13D. As a result, after the cap member 13c comes into contact with the nozzle forming surface 91 in step M12, the cap members 13b and 13d come into contact with the nozzle forming surface 91, as shown in step M13. In step M13, the cap member 13a is spaced a distance va3 from the nozzle forming surface 91, and the cap member 13e is spaced a distance of ve3 from the nozzle forming surface 91. The distances va3 and ve3 are the same.

If the cams CM1 to CM3 continue to further rotate from the state shown in step M13 in the counterclockwise direction, the cap members 13a and 13e further move in the cap moving direction. At this time, the cap members 13b, 13c, and 13d are all already in contact with the nozzle forming surface 91, and do not continue move in the cap moving direction +13D any further. Meanwhile, the cams CM2 and CM3 continue to rotate in the counterclockwise direction and the sliders 12b, 12c, and 12d continue to move in the cap moving direction +13D. Accordingly, the sliders 12b, 12c, and 12d move in the cap moving direction +13D against the force of the spring members SP2, which are respectively disposed between the sliders 12b, 12c, and 12d and the cap members 13b, 13c, and 13d. As a result, each of the cap members 13b, 13c, and 13d is pressed against the nozzle forming surface 91 with a force supplied by the spring members SP2.

As described above, among the curved surfaces CV1 to CV3, the curved surface CV1 has the smallest radius and thus a circumference that is the smallest distance from the shaft 41. Accordingly, the contact shafts U1 of the sliders 12a and 12e are the last sliders 12a-12e to move in the cap moving direction +13D. As a result, after the cap members 13b and 13d come into contact with the nozzle forming surface 91 in step M13, the cap members 13a and 13e come into contact with the nozzle forming surface 91, as shown in step M14.

The cams CM1 to CM3 further rotate in the counterclockwise direction from the state shown in step M14, and as a result, the sliders 12a to 12e continue to move in the cap moving direction +13D. At this time, the cap members 13a to 13e have already been in contact with the nozzle forming surface 91, and do not move any further in the cap moving direction +13D. Accordingly, the sliders 12a to 12e move in the cap moving direction +13D against the force of the spring members SP2, which are respectively disposed between the sliders 12a to 12e and the cap members 13a to 13e. As a result, each of the cap members 13a to 13e is pressed against the nozzle forming surface 91 in response to the force of the spring member SP2, as shown in step M15. In addition, as shown in step M15, the contact shaft U1 of each of the sliders 12a to 12e comes into contact with each of the corresponding cams CM (CM1-CM3) at their respective top points TP. If the operation shown in step M15 is completed, the capping operation for all of the cap members 13a to 13e is completed.

As such, in the first embodiment, the recording head 9 corresponds to the ‘liquid ejecting head’ of the invention, the nozzle forming surface 91 corresponds to the ‘nozzle opening plane’ of the invention, and each of the cap members 13 (13a-13e) corresponds to the ‘cap’ of the invention. In addition, the cam mechanisms 40 (40a-40e) and the sliders 12 (12a-12e) correspond to the ‘cap moving unit’ of the invention.

As described above, in the first embodiment, the capping operation is carried out for the five cap members 13a-13e spaced from the recording head 9 such that at least two cap members 13 among the five cap members 13a to 13e are brought into contact with the recording head 9 at different contact timings. Here, the contact timing means a timing at which, during the capping operation, the cap member 13 comes into contact with the recording head 9. For example, the cap member 13c comes into contact with the recording head 9 in step M12, while the cap members 13b and 13d comes into contact with recording head 9 in step M13. That is, the cap member 13c and the cap members 13b and 13d have different contact timings. In addition, the cap members 13a and 13e comes into contact with the recording head 9 in step M14. That is, the cap members 13a and 13e have a contact timing that is different from that of the cap members 13b to 13d.

Specifically, in the first embodiment, instead of bringing all five cap members 13a-13e into contact with the recording head 9 at the same time, at least two cap members 13 (for example, the cap members 13c and 13b) among the five cap members are brought into contact with the recording head 9 at different times. Accordingly, compared with a case where the five cap members 13a to 13e are all brought into contact with the recording head 9 at the same time, the load on the driving motor 402 that occurs when the cap members 13 come into contact with the recording head is reduced. Therefore, it is possible to prevent the driving motor 402 from stopping due to an excessive load caused by the contact timing. As a result, the cap members 13 can be appropriately brought into contact with and pressed against the recording head 9, thereby realizing an adequate capping process.

Meanwhile, when the cap members come into contact with the recording head, a load is imposed on the recording head 9 from the cap members 13a-13e. In configurations where cap members 13 are brought into contact with the recording head 9 at different contact timings, a biased load on the recording head 9 may occur, and the recording head 9 may become excessively deformed. The excessive deformation may be accompanied by wear and abrasion of the recording head 9, and then the lifespan of the recording head may be shortened.

In contrast, in the first embodiment previously described, the five cap members 13a to 13e are symmetrically arranged along the arrangement direction 13AD parallel with the nozzle forming surface with a symmetry axis 13SA that is perpendicular to the nozzle forming surface 91 interposed there between. In the first embodiment, the cap members 13, which are arranged symmetrically with respect to the symmetry axis 13SA, among the five cap members 13a to 13e are brought into contact with the recording head 9 using a coordinated contact timing. Specifically, the cap members 13b and 13d come into contact with the recording head 9 at the same time, and the cap member 13a and the cap member 13e come into contact with the recording head 9 at the same time. Accordingly, the load imposed on the recording head 9 occurring when the cap members 13a to 13e come into contact therewith is symmetrically distributed on the recording head 9 with respect to the symmetry axis 13SA. Therefore, it is possible to suppress the biasing of any load on the recording head 9 when the cap members come into contact therewith. As a result, according to the first embodiment, it is possible to extend the lifespan of the recording head.

In configurations where the recording head 9 is flexed by its own weight, the degree of flexure tends to be larger around the symmetry axis 13SA. That is, the recording head 9 tends to be flexed the greatest amount around the symmetry axis 13SA. For this reason, in the first embodiment, when the capping operation is carried out for all of the five cap members 13a-13e, the cap member 13c, which is closest to the symmetry axis 13SA from among the five cap members 13a-13e is brought into contact with the recording head at the earliest contact timing (Step M12). That is, in the first embodiment, when the capping operation is carried out for all of the five cap members 13a to 13e, the cap member 13c closest to the symmetry axis 13SA is initially brought into contact with the recording head, thereby suppressing the flexure around the symmetry axis 13SA.

In the first embodiment, when the capping operation is carried out for all of the five cap members 13a-13e, the cap member 13c, which is the closest to the symmetry axis 13SA, is brought into contact with the recording head 9 at the earliest contact timing. By setting the contact timing in this manner, when the capping operation is carried out for all of the five cap members 13a to 13e, it is possible to suppress the flexure of the recording head 9, which is maximized around the symmetry axis 13SA.

In the first embodiment, the printer 1 has a spring member SP2 for each of the five cap members 13a to 13e, one end of which is connected to the cap member 13 on the rear side of the recording head 9, while the other end is connected to the slider 12. The slider 12 moves in the cap moving direction +13D due to the driving force from the driving motor 402 (shown in FIGS. 6 and 15). Furthermore, in the first embodiment, during the capping operation for the cap members 13a-13e, the slider 12 is moved toward the recording head 9, such that the cap member 13, which is connected to the slider 12 through the spring member SP2, is brought into contact with the recording head 9. In addition, in the first embodiment, when the cap member 13 is in contact with the recording head 9, the slider 12 is moved further toward the recording head 9 against the force of the spring member SP2 so as to press the cap member 13 against the recording head 9. In this case, the resistant force of the spring member SP2 is the greatest at the top point TP. Here, in order to change the contact timings of the five cap members 13a to 13e, the shapes and rotation directions of the cams may be modified. In this case, however, even after the resistant force of the spring member SP2 is maximized, further rotation may be needed to bring the next cap member into contact with the nozzle surface. Unfortunately, however, the additional rotation on the cam surfaces may cause the surfaces of the cams to be abraded. In the first embodiment, the five cap members have different contact timings, but all reach the top point at the same time, meaning that it is possible to prevent the cams from being abraded due to addition rotation beyond the top point.

When the capping operation for all of the five cap members 13a-13e is completed, and all of the five cap members 13a-13e are pressed against the recording head 9, a load corresponding to the resistant force of the spring member SP2 connected to each of the cap members 13a-13e is imposed on the recording head 9 from each of the cap members 13a-13e. Accordingly, if the resistant force varies among the cap members 13a-13e, a biased load on the recording head 9 may occur, and then the recording head 9 may become excessively deformed.

During the capping operation for the cap members 13a-13e, the five cap members 13a-13e are preferably pressed against the recording head with the same urging force. With this configuration, at the time of pressing the five cap members 13a-13e, the same load can be imposed on the recording head 9 from the cap members 13a-13e, thereby suppressing the deformation of the recording head 9.

Meanwhile, as described above with reference to FIG. 14, the position of the top point TP varies according to the cams CM1 to CM3, and the relative distance between the contact shafts U1 and U2 and the shaft 41 in the capping state varies according to the cams CM1 to CM3 as shown in step M15. As a result, the lengths of the spring members SP2 connected thereto are different from each other. Accordingly, if all of the spring members SP2 have the same configuration, a difference in the urging force for pressing the cap members 13a-13e may be generated. In this case, the spring members SP2 may be configured to correspond to the difference in the resistant force, but this method is not preferable since it increases the complexity of the configuration. In the second embodiment described more fully below, a technology capable of equalizing the urging force to be applied to the cap members 13a-13e in the capping state will be described.

### Second Embodiment

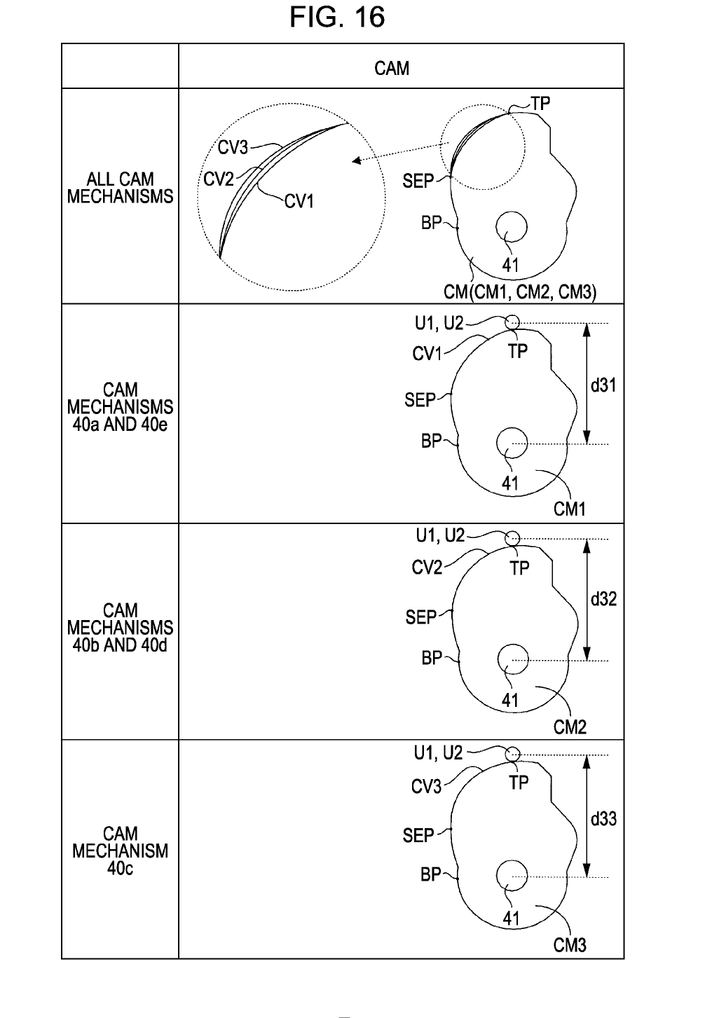

FIG. 16 is a diagram showing the configuration of a cam according to a second embodiment of the invention. The second embodiment differs from the first embodiment in the configuration of the cam, while other parts of the second embodiment are the same as those in the first embodiment. Hereinafter, only the configuration of the cam will be described, and the descriptions of the parts other than the cam will be omitted.

A cam CM1 shown in the row entitled CAM MECHANISMS 40a AND 40e” of FIG. 16 is a cam that is provided in the cam mechanisms 40a and 40e. That is, the cam CM1 corresponds to the cam 43a, 44a, 43e, or 44e. A curved surface CV1 is formed at the side surface of the cam CM1 from the bottom point BP to the top point TP. In addition, the relative distance between the contact shafts U1 and U2, which come into contact with the top point TP, and the shaft 41 is the relative distance d31. That is, in each of the cam mechanisms 40a and 40e, the relative distance in the capping state becomes the relative distance d31.

The cam CM2 shown in the row entitled CAM MECHANISMS 40b AND 40d” is provided in the cam mechanisms 40b and 40d. That is, the cam CM2 corresponds to the cam 43b, 44b, 43d, or 44d. As shown in that row, a curved surface CV2 is formed at the side surface of the cam CM2 from the bottom point BP to the top point TP. In addition, the relative distance between the contact shafts U1 and U2, which come into contact with the top point TP, and the shaft 41 is a relative distance d32. That is, in each of the cam mechanisms 40b and 40d, the relative distance in the capping state becomes the relative distance d32.

The cam CM3 shown in the row entitled “CAM MECHANISM 40c” is provided in the cam mechanism 40c. That is, the cam CM3 corresponds to the cam 43c or 44c. As shown in that row, a curved surface CV3 is formed at the side surface of the cam CM3 from the bottom point BP to the top point TP. In addition, the relative distance between the contact shafts U1 and U2, which come into contact with the top point TP, and the shaft 41 is a relative distance d33. That is, in the cam mechanism 40c, the relative distance in the capping state becomes the relative distance d33.

In the row entitled “ALL CAM MECHANISMS” at the top of FIG. 16, the cams CM1, CM2, and CM3 are shown in an overlapping manner. As illustrated in the diagram, the cams CM1 to CM3 have different side surface shapes that vary from the bottom point BP to the top point TP. That is, the shapes of the curved surfaces CV1 to CV3 are different from each other. Specifically, the shapes of the curved surfaces CV1 to CV3 vary after a separation point SEP to the top of the cams CM1 to CM3. Here, the separation point SEP is a point that, for each of the curved surfaces CV1 to CV3, is provided between the bottom point BP and the top point TP. That is, after the separation point SEP, the curved surfaces CV1 to CV3 have respectively increasing radiuses. However, at the top point TP, the curved surfaces CV1 to CV3 conform to each other. Accordingly, the dimensional relationship of the relative distances d31 to d33 corresponding to the cams CM1 to CM3 is as follows: relative distance d33=relative distance d32=relative distance d31. That is, the relative distances are equalized without depending on the cams CM1 to CM3.

As such, in the second embodiment, similar to the first embodiment, the cams CM1 to CM3 are configured such that, after the separation point SEP, the curved surfaces CV1 to CV3 vary. Accordingly, by carrying out the operations of steps M11 to M15 described with reference to FIG. 15, the cap member 13c comes into contact with the recording head 9 at the earliest contact timing, the cap members 13b and 13d come into contact with the recording head 9 at a contact second contact timing after the cap member 13c, and the cap members 13a and 13e come into contact with the recording head 9 at a latest timing.

Accordingly, similarly to the first embodiment, in the second embodiment, the load on the driving motor 402 (driving source) occurs when the cap member 13 comes into contact with the recording head can be reduced. Therefore, it is possible to prevent the driving motor 402 (driving source) from stopping due to the excessive load at the contact timing. As a result, the cap member 13 can be appropriately brought into contact with and pressed against the recording head 9, thereby realizing a good capping state. In addition, in the second embodiment, the cap members 13, which are arranged symmetrically with respect to the symmetry axis 13SA, among the five cap members 13a to 13e are brought into contact with the recording head 9 at the same time. Accordingly, a load on the recording head 9 that occurs when the cap members 13a-13e come into contact with the recording head 9 may be symmetrically imposed on the recording head 9 with respect to the symmetry axis 13SA. Therefore, it is possible to prevent a biased load from being applied on the recording head 9 when the cap members are brought into contact therewith. As a result, the lifespan of the recording head can be extended.

In addition, in the second embodiment, the curved surfaces CV1 to CV3 conform to each other at the top point TP. Accordingly, in the capping state (step M15), the relative distances are the same regardless of the individual configurations of the cams CM1 to CM3. As a result, in the capping state, the spring members SP2, which are correspondingly connected to the cap members 13a to 13e, may have the same length. That is, the spring members SP2 correspondingly connected to the cap members 13a-13e may have the same configuration. In this way, in a state in which the capping operation for the cap members 13a-13e is completed, the five cap members 13a-13e are pressed against the recording head 9 with the same resistant force. As such, in the second embodiment, only by making all of the spring members SP2 the same, the same load can be imposed on the recording head 9 from the cap members 13a-13e. Therefore, according to the second embodiment, it is preferable to suppress the deformation of the recording head 9 without greatly increasing the complexity of the configuration.

Furthermore, in order to change the contact timings of the five cap members 13a-13e, a method that changes the timing by making the shapes of all of the cams identical and shifting the cams little at a time in the rotation direction may be performed. In this case, however, even after the resistant force of the spring member SP2 is maximized, further rotation may be needed, and accordingly, the cams may be easily abraded. In the second embodiment, since the five cap members have different contact timings, but still reach the top point at the same time, it is possible to prevent the cams from being abraded due to further rotation beyond the state of the top point.

### Others

The invention is not limited to the foregoing embodiments, and various changes or modifications may be made without departing from the spirit of the invention. For example, in the foregoing embodiments, the number of cap members 13 is 5, but the number of cap members is not limited to 5 and may be increased or decreased depending on the specific configuration of the recording head 9. As may be understood by one of ordinary skill in the art, the invention can be applied insofar as three or more cap members 13 are provided.

In the foregoing embodiments, when the capping operation is carried out for all of the five cap members 13a-13e, the cap member 13c closest to the symmetry axis 13SA among the five cap members 13a-13e is brought into contact with the recording head 9 at the earliest contact timing (step M12). However, the fact that the cap member 13c closest to the symmetry axis 13SA is brought into contact with the recording head 9 at the earliest contact timing is not an essential part of the invention. With this configuration, it is merely preferable to suppress the flexure around the symmetry axis 13SA when the capping operation is carried out for all of the five cap members 13a-13e.

Finally, the invention is not limited to a printer and may be applied in a variety of liquid ejecting apparatuses, such as display manufacturing apparatuses, electrode manufacturing apparatuses, chip manufacturing apparatuses, micropipettes, and the like.

What is claimed is:

1. A liquid ejecting apparatus, comprising:
a liquid ejecting head comprising nozzles capable of ejecting a liquid from a plurality of nozzle openings formed in a nozzle opening plane;
a cap array that has three or more caps symmetrically arranged in an arrangement direction that is parallel with the nozzle opening plane with a symmetry axis that is perpendicular to the arrangement direction, which are capable of moving in a cap moving direction to be brought into contact with the liquid ejecting head, so as to enclose the nozzle openings;
a cap moving unit that is capable of performing a capping operation for each cap, where each cap is moved toward the liquid ejecting head in the cap moving direction so as to be brought into contact with the liquid ejecting head at a series of predetermined contact timings, and pressed against the liquid ejecting head;
a driving source capable of supplying a driving force for moving the caps toward the cap moving unit;
wherein at least two of the caps are brought into contact with the liquid ejecting head at different contact timings, and wherein caps arranged symmetrically with respect to the symmetry axis are brought into contact with the liquid ejecting head at the same contact timing.

2. The liquid ejecting apparatus according to claim 1,
wherein the cap that is closest to the symmetry axis is brought into contact with the liquid ejecting head at the earliest contact timing.

3. The liquid ejecting apparatus according to claim 1,
wherein the caps that are closer to the symmetry axis are brought into contact with the liquid ejecting head at an earlier contact timing than the caps that are located further from the symmetry axis.

4. The liquid ejecting apparatus according to claim 1,
wherein the cap moving unit has a spring member for each cap, wherein one end of the each spring member is connected to the corresponding cap along a rear side of the liquid ejecting head, and the other end of the spring member is connected to a slider which is capable of moving during a capping operation in the cap moving direction due to the driving force from the driving source, such that the cap moving unit moves the slider toward the liquid ejecting head, causing the cap to come into contact with the liquid ejecting head and causing the spring member to press the cap against the liquid ejecting head, and
wherein the resistive force used by the spring member to press the cap against the liquid ejecting head is the same for all the spring members.

5. The liquid ejecting apparatus according to claim 4, wherein the spring members all have the same length.

6. A method of controlling a liquid ejecting apparatus including a liquid ejecting head, which has a plurality of nozzles capable of ejecting a liquid from nozzle openings formed in a nozzle opening plane of the liquid ejecting head and a cap array comprised of three or more caps capable of moving in a cap moving direction toward and contacting the liquid ejecting head so as to enclose the nozzle openings of the liquid ejecting head, the method comprising:
performing a capping operation using a driving force capable of moving the caps toward the liquid ejecting head in the cap moving direction, bringing the caps into contact with the liquid ejecting head at a series of predetermined contact timings, and pressing the caps against the liquid ejecting head,
wherein the caps are symmetrically arranged in an arrangement direction that is parallel with the nozzle opening plane with a symmetry axis perpendicular to the arrangement direction, and
wherein at least two caps are brought into contact with the liquid ejecting head at different contact timings, and wherein caps that are arranged symmetrically with respect to the symmetry axis are brought into contact with the liquid ejecting head at the same contact timing.

7. The method according to claim 6, wherein driving force causes the cap that is closest to the symmetry axis is brought into contact with the liquid ejecting head at the earliest contact timing.

8. The method according to claim 6, wherein driving force causes the caps that are closer to the symmetry axis are brought into contact with the liquid ejecting head at an earlier contact timing than the caps that are located further from the symmetry axis.

9. A capping apparatus capable of capping a plurality of nozzle openings that are symmetrically arranged in an arrangement direction in a nozzle opening plane of a liquid ejecting head, the capping apparatus comprising:
a cap array that has three or more caps arranged so as to correspond with the nozzle openings, the caps being capable of moving in a cap moving direction, contacting the liquid ejecting head, and enclosing the nozzle openings;
a cap moving unit that is capable of performing a capping operation for each nozzle opening wherein the caps are moved toward the liquid ejecting head in the cap moving direction, brought into contact with the liquid ejecting head at a series of at least two predetermined contact timings, and pressed against the liquid ejecting head;
a driving source capable of supplying a driving force to move the caps toward the cap moving unit;
wherein each group of caps located an equal distance from the symmetry axis are brought into contact with the liquid ejecting head at the same contact timing.

10. The capping apparatus according to claim 9,
wherein a group of caps lies along the symmetry axis and is brought into contact with the liquid ejecting head at the first contact timing.

11. The capping apparatus according to claim 9,
wherein the predetermined contact timings correspond to the arrangement of the caps such that groups of caps that are closer to the symmetry axis are brought into contact with the liquid ejecting head before groups of two caps that are farther from the symmetry axis.

12. The capping apparatus according to claim 9,
wherein the cap moving unit has a spring member for each cap, wherein one end of the each spring member is connected to the corresponding cap along a rear side of the liquid ejecting head, and the other end of the spring member is connected to a slider which is capable of moving during a capping operation in the cap moving direction due to the driving force from the driving source, such that the cap moving unit moves the slider toward the liquid ejecting head, causing the cap to come into contact with the liquid ejecting head and causing the spring member to press the cap against the liquid ejecting head, and
wherein the resistive force used by the spring member to press the cap against the liquid ejecting head is the same for all the spring members.

13. The capping apparatus according to claim 9, wherein the spring members all have the same length.
